(19) United States
(12) Patent Application Publication
(10) Pub. No.: US 2005/0109128 A1
(43) Pub. Date: May 26, 2005

(54) Method and device for sampling gaseous compounds contained in a gas steam, notably in diluted exhaust gases from an internal-combustion engine

(76) Inventors: Michel Pasquereau, Sartrouville (FR); Jean-Francois Papagni, Saint Remy Les Chevreuses (FR); Patrick Thoral, Vaureal (FR); Richard Levesque, Suresnes (FR); Laurent Dayde, Suresnes (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/985,947

(22) Filed: Nov. 12, 2004

(30) Foreign Application Priority Data
Nov. 14, 2003 (FR) 03/13.397

(51) Int. Cl. G01N 1/22

(52) U.S. Cl. 73/863.21; 73/863.23

(57) ABSTRACT

The present invention relates to a method and to a device for sampling gaseous compounds contained in a gas stream, notably in diluted exhaust gases from an internal-combustion engine.

According to the invention, the method consists in providing passage of the gas stream through at least one sampling channel (26, 26a; 80, 80a) containing an adsorbent that traps the polycyclic aromatic hydrocarbons in gaseous form.

### FIELD OF THE INVENTION

The present invention relates to a method and to a device for sampling gaseous compounds contained in a gas stream, notably polycyclic aromatic hydrocarbons contained in diluted exhaust gases from an engine, in particular an internal-combustion engine.

More particularly, it is aimed at a method and a device for sampling from internal-combustion engines used within the context of test cells, roller type test dynamometers or engine test benches.

### BACKGROUND OF THE INVENTION

Some Polycyclic Aromatic Hydrocarbons (PAHs) are generally considered to be toxic pollutants harmful to man's health and all possible means to identify, quantify and process them if necessary are sought.

These PAHs are notably present in the exhaust gases of engines, in gaseous form for PAHs whose molecular structure is less than four rings or in condensed form in the particle phase of these gases for PAHs having a molecular structure greater than four rings.

It is already well-known to sample, identify and quantify PAHs condensed in the particle phase and contained in exhaust gases from an internal-combustion engine, notably for motor vehicles.

To carry out these operations, the exhaust gases are first diluted in a tunnel, then the particles contained in these gases are recovered by means of a generally Teflon-coated filter. The particles retained by this filter are then extracted by means of an organic solvent and a representative part of the soluble fraction collected is analysed by any means, such as chromatography.

In some types of internal-combustion engines, notably gasoline engines, the PAHs present in the particle phase are practically nonexistent in the exhaust gases and the major part of the PAHs is in the gaseous form. In this case, the sampling operation performed is not representative of the PAHs present in the exhaust gases.

A method allowing indirect characterization of the PAHs in gaseous form present in exhaust gases by trapping the hydrocarbons higher than C14 is also well known. From these trapped hydrocarbons, the PAHs in gaseous form are extracted according to long protocols, then identified and quantified by means of complex analysis equipments. These various operations can entail considerable PAH loss or contamination risks.

The present invention aims to overcome the aforementioned drawbacks by means of a method and of a device allowing simple and efficient sampling of the PAHs in gaseous form and quantification thereof by means of commonly used extraction and analysis equipments.

### SUMMARY OF THE INVENTION

The present invention thus relates to a method for sampling gaseous compounds contained in a gas stream, notably in diluted exhaust gases from an internal-combustion engine, characterized in that it consists in providing passage of the gas stream through at least one sampling channel containing an adsorbent intended to trap the polycyclic aromatic hydrocarbons in gaseous form.

Advantageously, the method can consist in carrying out filtration of the gas stream before passage thereof through the adsorbent.

It can consist in providing passage of the gas stream through a first sampling channel, in stopping passage of the gas stream through the first sampling channel and in providing passage of the gas stream through a second sampling channel.

In the case where the gas stream is first diluted by a dilution air, the method can consist in providing passage of the dilution air through at least one sampling channel containing an adsorbent trapping the polycyclic aromatic hydrocarbons in gaseous form.

It can also consist in providing passage of the dilution air through a first sampling channel, in stopping passage of the dilution air through said first sampling channel and in providing passage of this air through a second sampling channel.

Preferably, it can consist in filtering the dilution air prior to its passage through the adsorbent.

An adsorbent containing a resin based on porous polymers can be used.

This resin can be a resin with a matrix of polyaromatic styrene/divinylbenzene type.

The invention also relates to a device for sampling gaseous compounds contained in a gas stream, notably in diluted exhaust gases from an internal-combustion engine, characterized in that it comprises a sampling unit provided with at least one sampling circuit comprising at least one sampling means containing an adsorbent that traps the polycyclic aromatic hydrocarbons in gaseous form contained in said stream.

The sampling circuit can comprise a means for filtering the dilution air before it is mixed with the gas stream, when said gas stream contains such a dilution air.

The sampling circuit can comprise at least one sampling means containing an adsorbent that traps the polycyclic aromatic hydrocarbons in gaseous form contained in said dilution air.

The sampling means can comprise at least one cartridge containing the adsorbent.

The adsorbent can comprise a resin based on porous polymers.

The sampling circuit can comprise a gas stream filtration means.

The sampling unit can comprise two sampling circuits and throttling means to actuate one or other of the sampling circuits.

The device can comprise a control unit controlling the sampling unit.

### BRIEF DESCRIPTION OF THE FIGURES

Other features and advantages of the invention will be clear from reading the description hereafter, given by way of non limitative example, with reference to the accompanying drawings wherein:

FIG. 1 is a diagrammatic view of a sampling device according to the invention in a first configuration,

FIG. 2 is a cross-sectional view of a cartridge used in the device of FIG. 1, and

FIG. 3 is a diagrammatic view of the sampling device according to the invention in another configuration.

### DETAILED DESCRIPTION

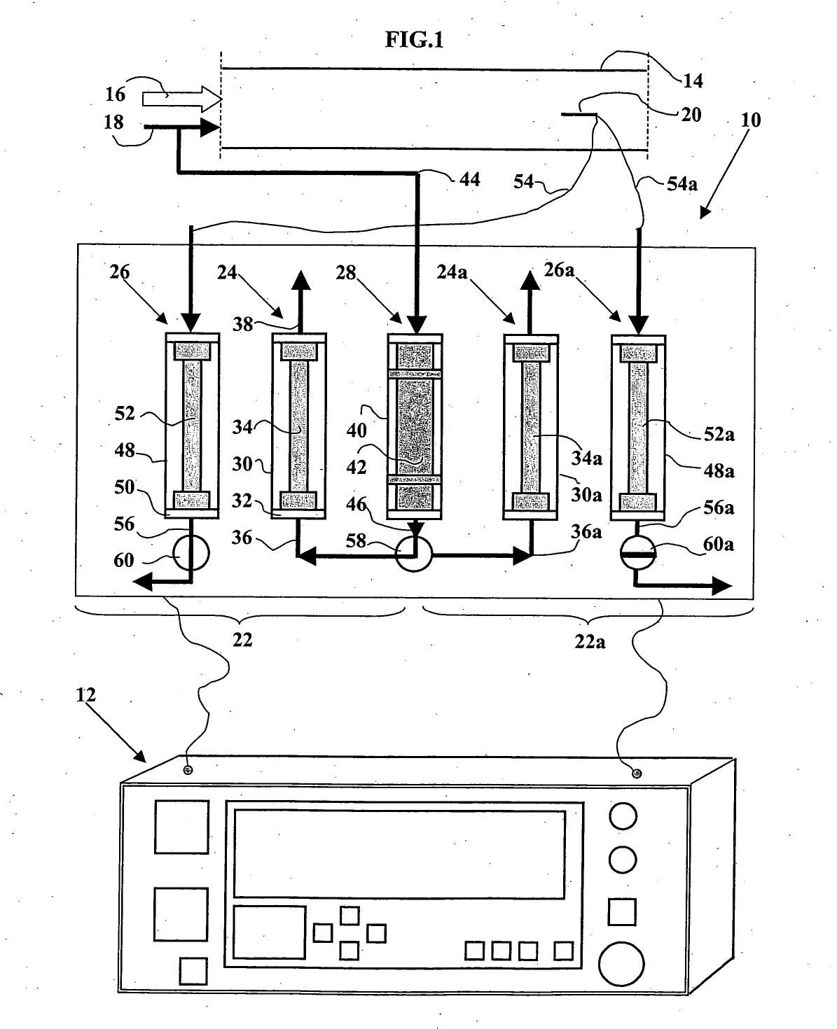

In FIG. 1, the device for sampling the Polycyclic Aromatic Hydrocarbons (PAHs) in gaseous form contained in a gas stream, such as diluted exhaust gases from an internal-combustion engine placed on a roller type test dynamometer, comprises a sampling unit 10 and a control unit 12 controlling unit 10.

This sampling device is associated with a sampling tunnel 14 which, in the roller type test dynamometer configuration, is a full-flow dilution tunnel in which exhaust gases 16 from the internal-combustion engine circulate. This tunnel is supplied with dilution air, generally treated ambient air, through a line 18 so as to obtain, at sampling head 20 located close to the tunnel outlet, diluted exhaust gases meeting the current sampling criteria (temperature, water content, . . . ).

Sampling unit 10 comprises at least one circuit 22 for sampling the PAHs in gaseous form, two in the present case, comprising each two sampling channels, a channel 24 for sampling the PAHs contained in the dilution air and a channel 26 for the PAHs contained in the diluted exhaust gases, as well as a dilution air filtration channel 28.

Channel 24 for sampling the PAHs contained in the dilution air comprises a collection unit 30 including a support 32 in which a removable sampling cartridge 34 is arranged. Dilution air filtered beforehand by filtration channel 28 and fed through a line 36 flows through cartridge 34. A line 38 allows the dilution air to be discharged after collection of the PAHs and sent to any known devices.

Filtration channel 28 comprises a filtration unit 40 with at least one filter 42 intended to collect all the impurities contained in the dilution air that flows through this filter. The inlet of filtration unit 40 is connected by a line 44 to dilution air line 18 and the outlet of this unit is connected by an outlet line 46 to line 36 leading to the inlet of collection unit 30.

Channel 26 for sampling the PAHs contained in the diluted exhaust gases collected by sampling head 20 comprises a collection unit 48 with a support 50 in which a removable sampling cartridge 52 is arranged. The inlet of collection unit 48 is connected by a line 54 to diluted gas sampling head 20 and the outlet of this unit is connected by a line 56 to any known means allowing the exhaust gases to be discharged and treated. As it is known in the art, the exhaust gases circulating in line 54 are already filtered, advantageously downstream from head 20, which allows to eliminate the impurities likely to clog sampling cartridge 50.

Advantageously, supports 32, 50 and cartridges 34, 52 can be identical for both sampling channels.

As shown in FIG. 1, sampling unit 10 comprises a second circuit 22a for sampling the PAHs in gaseous form, comprising two sampling channels 24a, 26a with the same components as described for circuit 22. Of course, for device simplification reasons, the same filtration channel 28 is used for circuit 22a. This allows two successive distinct sampling operations to be carried out without having to stop the PAH sampling procedure or the engine. A throttling means 58 such as a three-way valve is therefore provided on outlet line 46 of filtration unit 40, which allows to alternately communicate either line 36 or line 36a. Similarly, lines 56 and 56a are each fitted with a throttling means 60 and 60a, such as a two-way valve of rotary or other type, allowing to provide or to stop the supply of diluted exhaust gases to collection units 48 and 48a. Valves 60 and 60a are controlled in such a way that they are never simultaneously in open or closed position. Thus, when sampling circuit 22 is operational, line 36 communicates with line 46 through the action of valve 58, valve 60 is in open position to allow passage of the exhaust gases into sampling channel 26 and valve 60a is in closed position to prevent circulation of these gases in sampling channel 26a.

Control unit 12 allows, as it is known in the art, to parametrize, to permanently control and/or check the sampling conditions, such as the flow rate, the pressure and the temperature of the exhaust gases and/or of the dilution air admitted at the inlet of the collection units, the sampling time, the actuation of the other sampling circuit 22a in the case of a two-circuit sampling unit, by actuating throttling means 58, 60 and 60a. This unit also controls all the devices linked with the operation of this sampling unit, such as the pumps allowing circulation of the gas stream in the dilution air filtration 26, 28 and sampling 24 channels.

It also comprises sound and/or visual alarms allowing to detect a possible malfunction or failure to respect a programmed parameter.

During the sampling process in the configuration of FIG. 1 corresponding to a vehicle used on a roller type test dynamometer, only sampling circuit 22 is used. In this configuration, valve 60 is in open position, valve 58 is actuated so as to communicate outlet line 46 of filtration channel 28 with inlet line 36 of sampling channel 24, and valve 60a is in closed position.

The exhaust gases 16 from the internal-combustion engine of this vehicle are mixed in tunnel 14 with dilution air carried by line 18. Part of this dilution air is sent, prior to being fed into tunnel 14, through line 44 into filtration channel 28 in order to be freed of the impurities it contains, such as dusts. This filtered dilution air is then sent into unit 30 for collecting the PAHs in gaseous form and flows through sampling cartridge 34. The PAHs in gaseous form are collected by the adsorbent contained in this cartridge and the dilution air freed of a large part of the PAHs is discharged at the outlet of unit 30 through line 38 and sent to any known means. Simultaneously, the diluted exhaust gases, that have been filtered beforehand, are sampled close to the outlet of this tunnel 14 by head 20 and sent through line 54 into unit 48 for collecting the PAHs in gaseous form. These gases flow through cartridge 52 and the PAHs in gaseous form present in these gases are retained by the adsorbent contained in this cartridge. The PAH-freed exhaust gases are then discharged through line 56 and sent to any known means in order to be treated prior to being discharged to the atmosphere.

Thus, during this process, the PAHs contained both in the dilution air and in the diluted exhaust gases are recovered by two sampling cartridges arranged in parallel.

As mentioned above, it is possible to carry out two successive PAH sampling operations without stopping the engine of the vehicle and the sampling device. After a first PAH sampling carried out in sampling circuit 22 by the cartridges of collection units 30 and 48, this sampling operation is stopped just by actuating throttling means 58 and 60 so as to break the circulation of the dilution air and of the diluted exhaust gases through the various filtration and sampling channels. After this stop, a second sampling of the PAHs contained in the dilution air and in the diluted exhaust gases can be carried out in sampling circuit 22a by collection units 30a and 48a, by acting on the opening of throttling means 58, 60a. In this configuration, filtration channel 28 used for the first sampling operation is advantageously used also for the second sampling operation.

Once the PAH sampling operation is over, cartridges 34, 52 are taken off from their supports 32, 50. These cartridges are then treated so as to extract the PAHs therefrom by means of a solvent such as dichloromethane or toluene. Advantageously, this extraction is carried out using an accelerated solvent extraction (ASE) system which has the advantage of using a very small amount of solvent, which saves an adsorbent reconcentration. Furthermore, the extraction system is suited to the configuration of the cartridges so as to avoid dismantling of their constituent elements or transfer of the adsorbent they contain.

The PAHs extracted for each cartridge are analysed by any means, in particular by coupling chromatography with mass spectrometry or by high-performance liquid chromatography, so as to identify and to quantify the PAHs contained in the dilution air and in the diluted exhaust gases.

After these analyses, identification and quantification of the PAHs in gaseous form finally contained in the exhaust gases are determined after deduction of the PAHs identified and quantified in the dilution air.

Advantageously, this sampling device is associated with any known means allowing to sample, to identify and to quantify the PAHs condensed in the particle phase of the exhaust gases.

Thus, the present invention allows to complete knowledge of the PAHs condensed in the particle phase contained in the exhaust gases by identification and quantification of the PAHs in gaseous form.

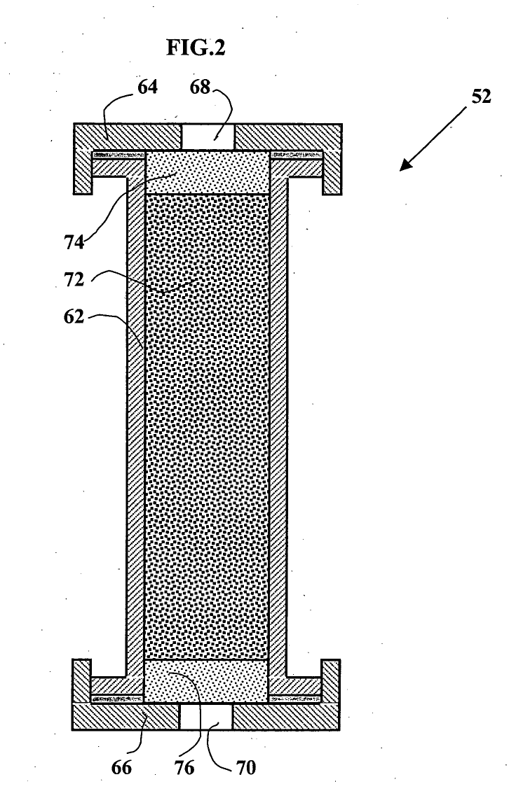

FIG. 2 shows an example of embodiment of sampling cartridge 52 used in unit 48 intended for collection of the PAHs contained in the exhaust gases. Advantageously, the same type of cartridge can be used in unit 30 intended for collection of the PAHs of the dilution air, and in collection units 30a and 48a. As mentioned above, these types of cartridge allow fast and simple adjustment, without any adsorbent handling by the extraction system used.

This cartridge 52 comprises a substantially cylindrical tubular body 62 closed at both ends by two removable covers 64, 66. Each cover is provided with a bore 68, 70 allowing to communicate the inside of body 62 with the exhaust gas inlet of line 54 and the exhaust gas outlet of line 56 respectively. The covers are tightly fastened to body 62 by any known means, by screwing for example. The body contains in its hollow volume an adsorbent 72 consisting of resin based on porous polymers, known as Amberlite. By way of example, the adsorbent is of the type marketed under the trade name XAD2 Supelpak and comprises a resin with a matrix of polyaromatic styrene/divinylbenzene type. A quartz wool bed 74, 76 is arranged between each cover 64, 66 and adsorbent 72 so as to immobilize this adsorbent inside body 62 without hindering circulation of the exhaust gases through these beds.

Advantageously, bores 68, 70 are designed in such a way that they can be shut off by any known means, such as O-ring caps, after removal of the cartridge from its support.

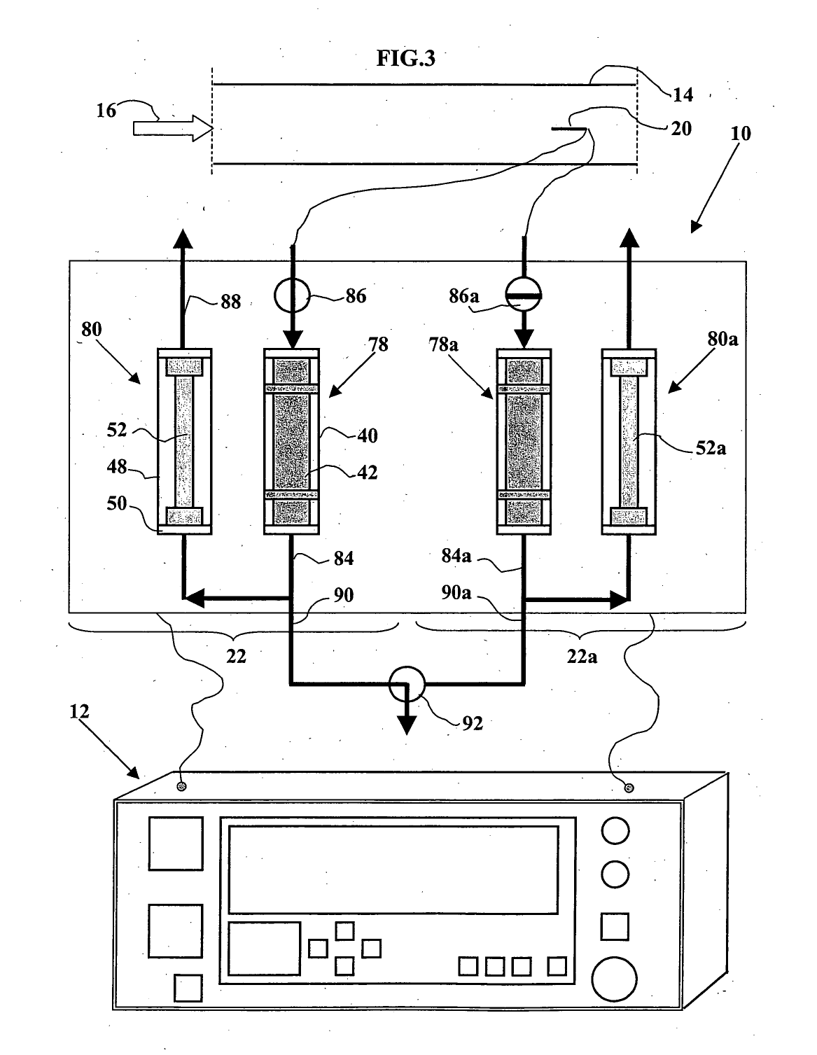

FIG. 3 shows the sampling device in another configuration referred to as engine test bench configuration.

In this configuration, sampling unit 10 also comprises two sampling circuits 22 and 22a and it is associated with a microtunnel 14 which contains a dilution air that is already purified and filtered.

Each sampling circuit comprises an exhaust gas filtration channel 78 connected to a sampling channel 80 intended for the PAHs in gaseous form contained in the filtered exhaust gases.

Filtration channel 78 comprises a filtration unit 40 similar to the unit described above, with at least one filter 42 for collecting all the impurities contained in the diluted exhaust gases that flow through this filter, an exhaust gas inlet line 82 leading these gases from head 20 to the inlet of unit 40 and an outlet line 84 for the filtered exhaust gases. The inlet line is provided with a throttling means 86, in form of a valve, allowing to provide or to prevent inflow of the diluted exhaust gases into this filtration unit 40.

Sampling channel 80 also comprises a collection unit 48 similar to the collection unit of FIG. 1, with a support 50 carrying a removable sampling cartridge 52. The inlet of collection unit 48 is connected to filtered gas outlet line 84 and the outlet of this unit is connected to a line 88 for discharging the PAH-free diluted exhaust gases.

Preferably, line 84 can comprise a bypass line 90 allowing to discharge part of the diluted and filtered exhaust gases, notably towards the microtunnel control system (not shown). In this case, a throttling means 92 such as a three-way valve allows to selectively communicate line 90 or line 90a with the microtunnel control system.

During operation, as illustrated by way of example in FIG. 3, only sampling circuit 22 is used. In this configuration, valve 86 is in open position so as to communicate, by means of line 82, the gases collected by sampling head 20 with filtration unit 40 and valve 92 is in a position allowing line 90 to discharge part of the exhaust gases after filtration. These diluted gases flow through filtration unit 40 so as to be freed of the impurities they contain. These filtered exhaust gases are then sent into unit 48 intended for collection of the PAHs in gaseous form through line 84 after flowing through sampling cartridge 52 and line 90. The PAHs in gaseous form are collected by the adsorbent contained in this cartridge, the PAH-free exhaust gases are discharged through line 88 and sent to any known means.

As already mentioned above in the configuration of FIG. 1, it is possible to carry out two successive PAH sampling operations without having to stop the engine of the vehicle and the sampling device. Thus, after the first PAH sampling operation carried out in sampling circuit 22 by collection unit 48, circulation of the exhaust gases in the filtration channel is stopped just by closing valve 86. Once this valve is closed, valve 92 is actuated to allow circulation of the filtered gases in valve 90a and valve 86a can be opened to allow circulation of the diluted exhaust gases in filtration channel 78a and in sampling channel 80a.

Once the PAH sampling operations are over, cartridge 52 is removed from its support 50 to be treated in order to extract therefrom, to identify and to quantify the PAHs as described for FIG. 1.

This sampling device will also be associated with any known devices allowing to sample, identify and quantify the PAHs present in condensed form in the particle phase of these gases.

1. A method for sampling gaseous compounds contained in a gas stream, notably in diluted exhaust gases from an internal-combustion engine, characterized in that it consists in providing passage of the gas stream through at least one sampling channel (26, 26a; 80, 80a) containing an adsorbent intended to trap the polycyclic aromatic hydrocarbons in gaseous form.

2. A method as claimed in claim 1, characterized in that it consists in carrying out filtration of the gas stream prior to its passage through the adsorbent.

3. A method as claimed in claim 1, characterized in that it consists in providing passage of the gas stream through a first sampling channel (26, 80), in stopping passage of the gas stream through the first sampling channel and in providing passage of the gas stream through a second sampling channel (26a, 80a).

4. A method as claimed in claim 1, wherein said stream is diluted by a dilution air, characterized in that it consists in providing passage of the dilution air through at least one sampling channel (24) containing an adsorbent trapping the polycyclic aromatic hydrocarbons in gaseous form.

5. A method as claimed in claim 4, characterized in that it consists in providing passage of the dilution air through a first sampling channel (24), in stopping passage of the dilution air through said first sampling channel and in providing passage of this air through a second sampling channel (24a).

6. A method as claimed in claim 4, characterized in that it consists in filtering the dilution air prior to its passage through the adsorbent.

7. A method as claimed in claim 1, characterized in that an adsorbent containing a resin based on porous polymers is used.

8. A method as claimed in claim 7, characterized in that a resin with a matrix of polyaromatic styrene/divinylbenzene type is used.

9. A device for sampling gaseous compounds contained in a gas stream, notably in exhaust gases from an internal-combustion engine, characterized in that it comprises a sampling unit (10) provided with at least one sampling circuit (22) comprising at least one sampling means (34, 52) containing an adsorbent that traps the polycyclic aromatic hydrocarbons in gaseous form contained in said stream.

10. A device as claimed in claim 9 wherein the gas stream contains a dilution air, characterized in that sampling circuit (22) comprises a means (40, 42) for filtering the dilution air before it is mixed with the gas stream.

11. A device as claimed in claim 10, characterized in that sampling circuit (22) comprises at least one sampling means (34, 52) containing an adsorbent that traps the polycyclic aromatic hydrocarbons in gaseous form contained in said dilution air.

12. A device as claimed in claim 9, characterized in that the sampling means comprises at least one cartridge (34, 52) containing the adsorbent.

13. A device as claimed in claim 9, characterized in that the adsorbent comprises a resin based on porous polymers.

14. A device as claimed in claim 9, characterized in that sampling circuit (22) comprises a gas stream filtration means (40, 42).

15. A device as claimed in claim 1, characterized in that sampling unit (10) comprise two sampling circuits (22, 22a) and throttling means (58, 60; 86, 92) for actuating one or other of the sampling circuits.

16. A device as claimed in claim 1, characterized in that it comprises a control unit (12) controlling sampling unit (10).
